(19) United States
(12) Patent Application Publication
(10) Pub. No.: US 2003/0193407 A1
(43) Pub. Date: Oct. 16, 2003

(54) Early warning emergency device

(76) Inventor: John Allen Russell, Torrance, CA (US)

Correspondence Address: John A. Russell, 22307 Kent Ave #36, Torrance, CA, 90505, US

(21) Appl. No.: 09/749,149

(22) Filed: Apr. 11, 2002

(51) Int. Cl. G08G 1/00

(52) U.S. Cl. 340/902

(57) ABSTRACT

The purpose and uniqueness of this device is best described by current devices such as 3M's device using infrared and devices using radar which is effective in direct line of sight and at short distances unlike EWD device utilizing transponders which doesn't require direct line of site and utilizing car stereo's to facilitate the activation of signal response in that the emergency vehicle transponder would activate receiver device signal received by other vehicle antenna's relaying the signal to the vehicle stereo in turn activating internal switch's and voice recorder/playback module which over rides internal stereo and bypasses it's normal relay of radio stations broadcast and announces twice to the driver that a emergency vehicle is approaching his location and then returns the device to normal mode weather the device is currently turned on or off.

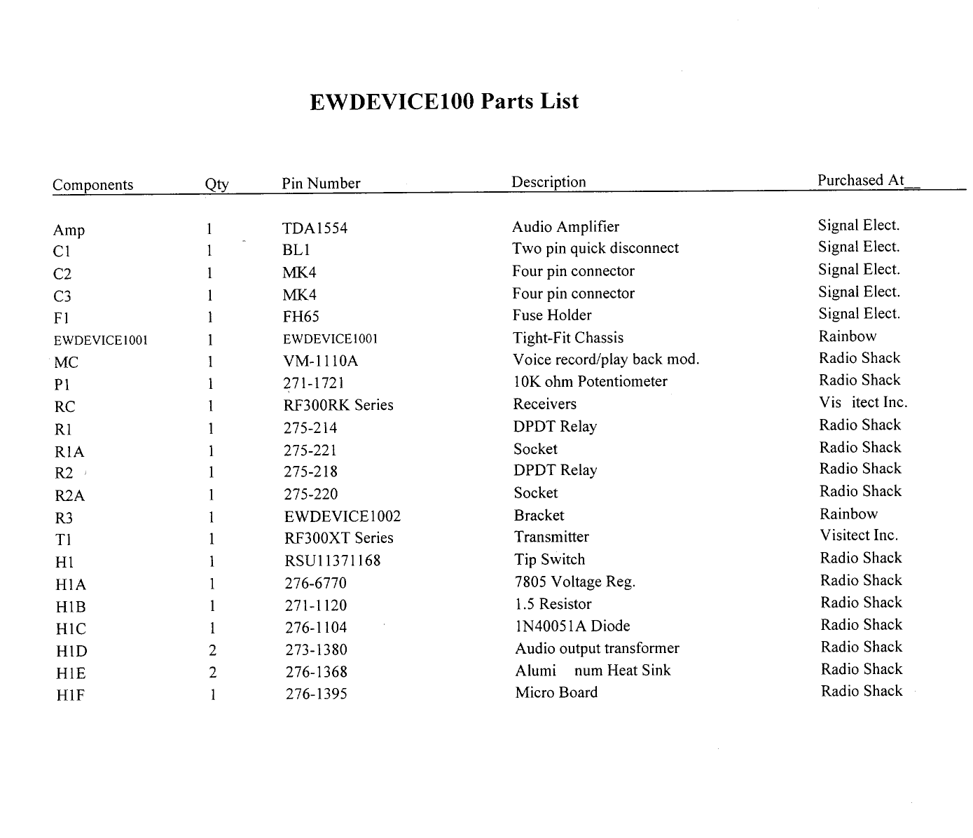

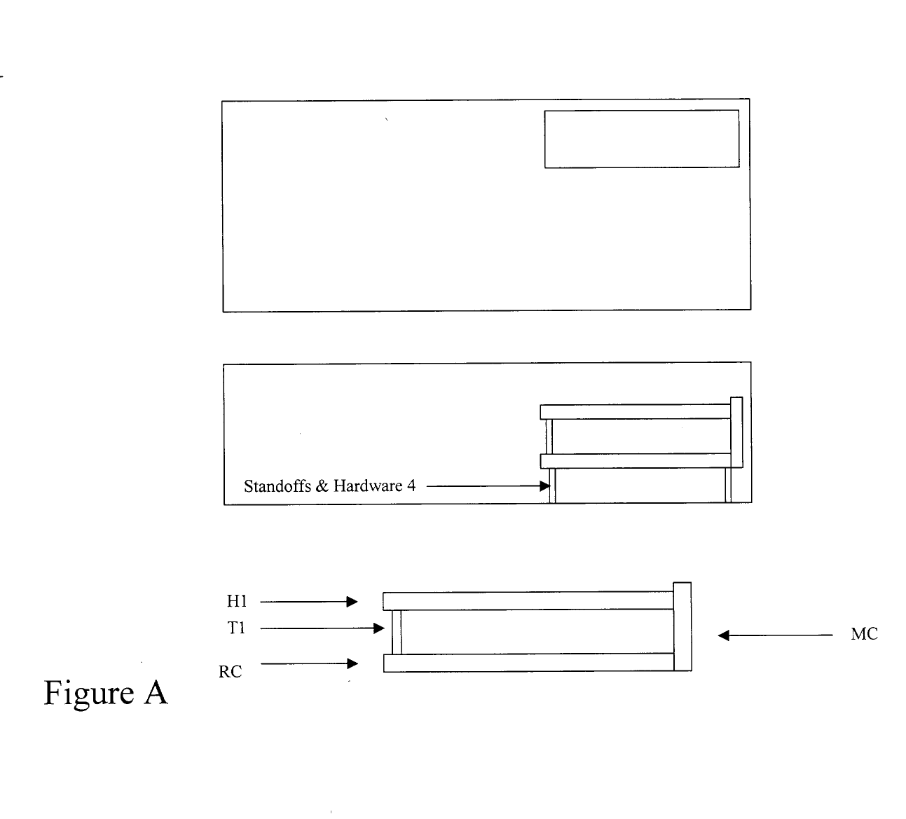

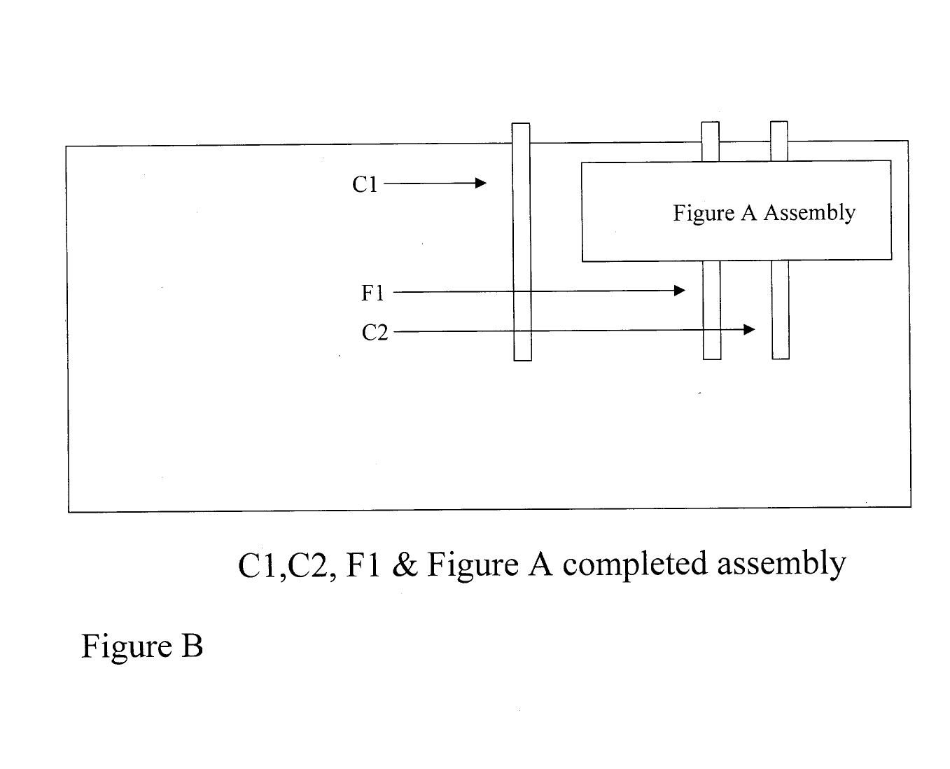

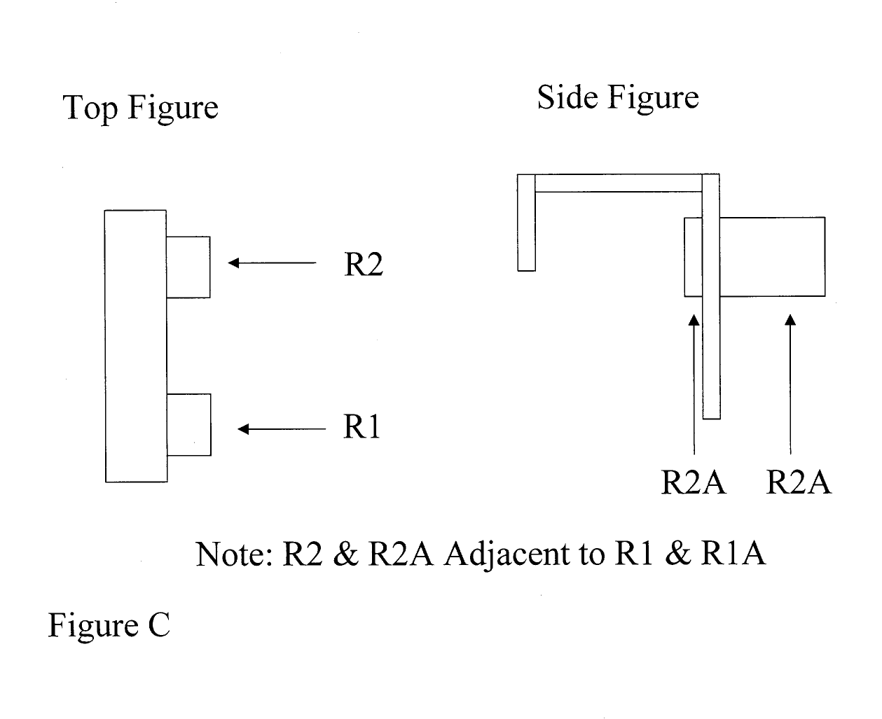

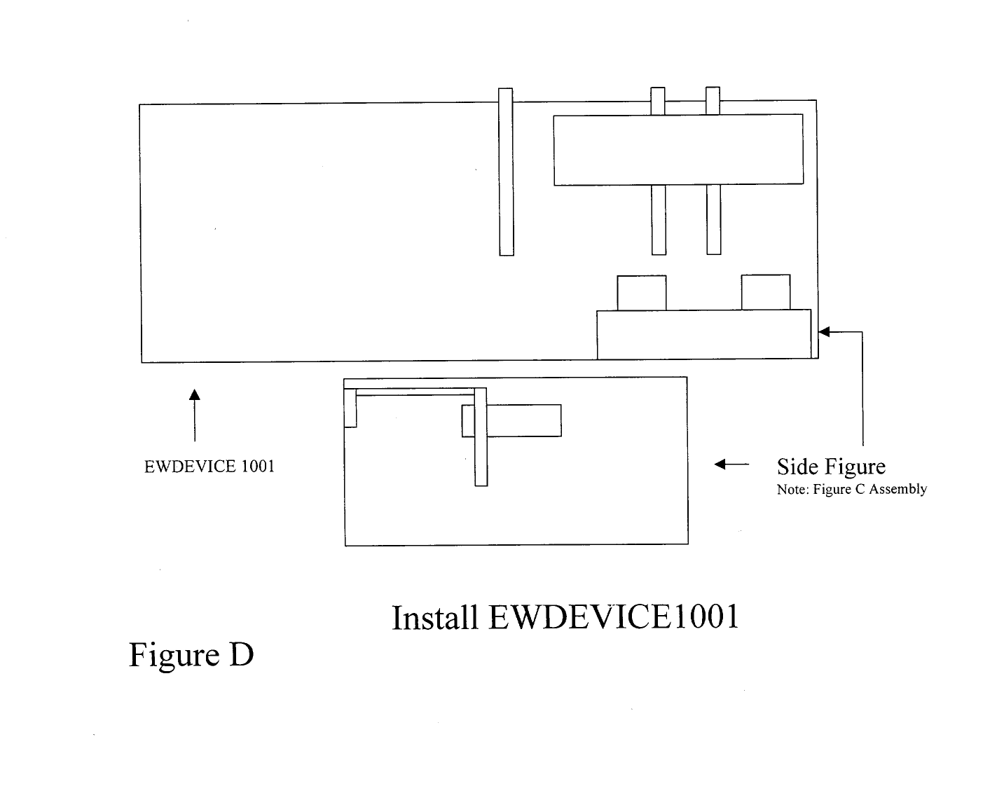

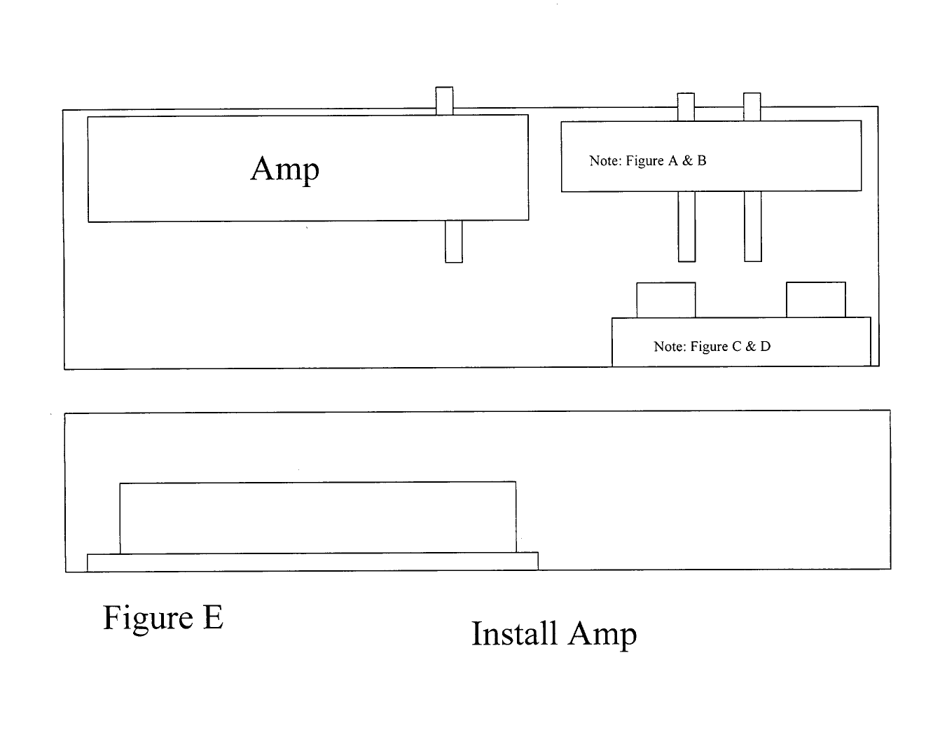

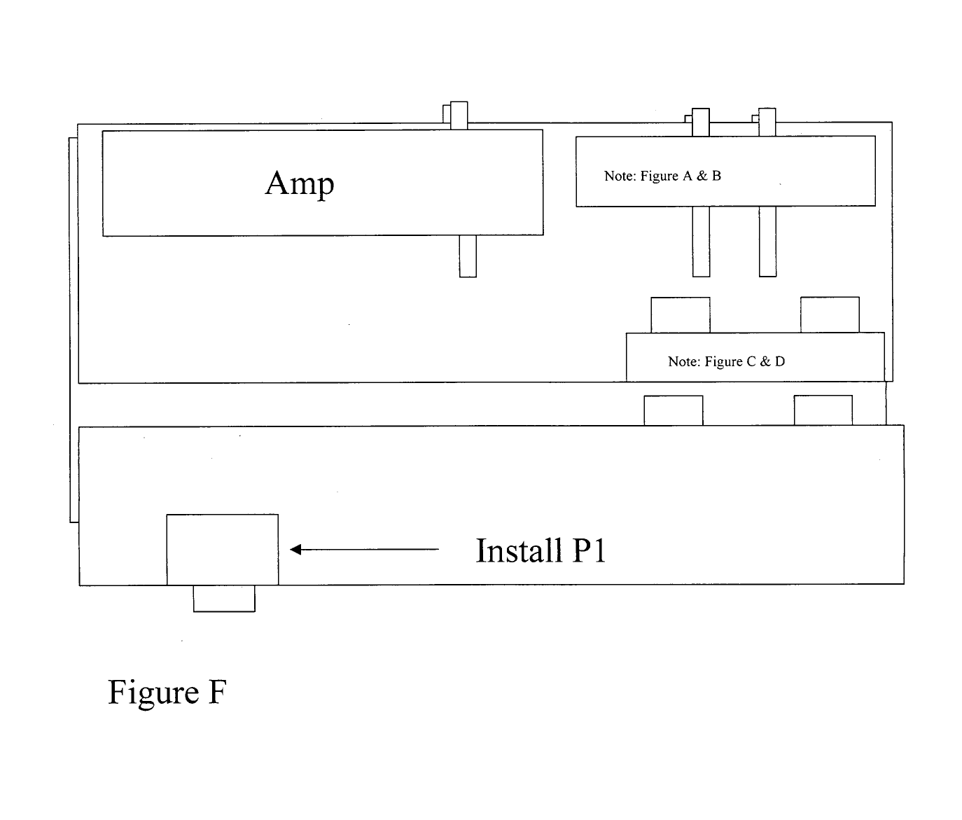

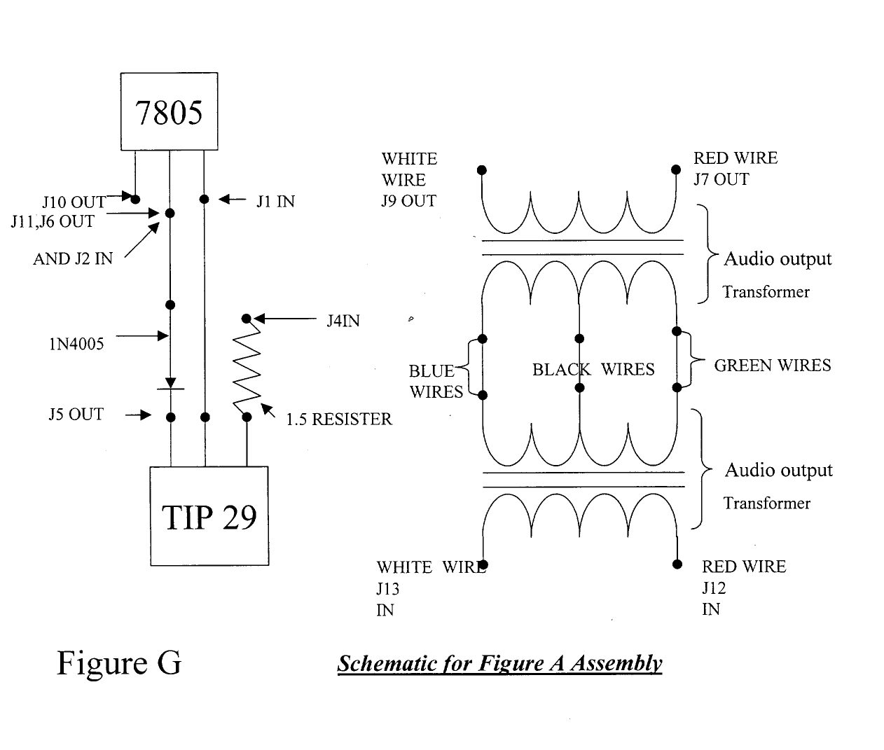

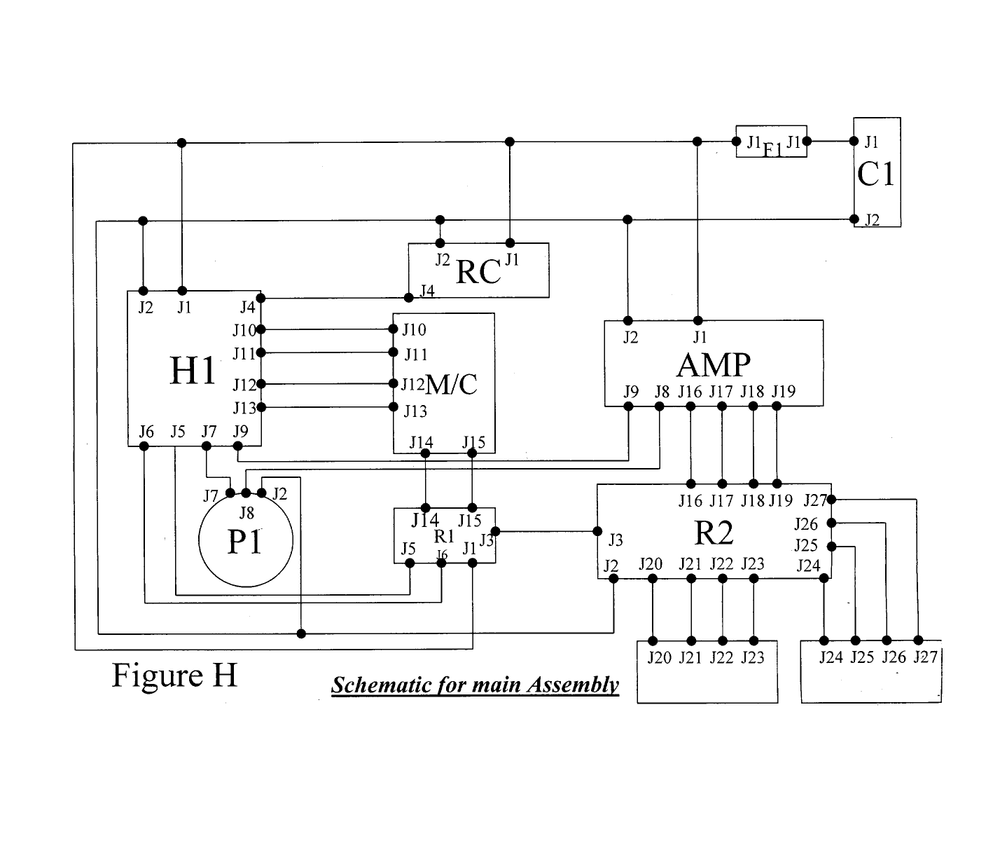

### EARLY WARNING DEVICE TECHNICAL DESCRIPTION

The device is made up of four major components, transmitter, receiver, amplifier and voice recording module.

The transmitter is high-end transmitter, designed to meet applications requiring extended transmission range, reliability and multiple signals. The transmission frequency is 318 mnz with a range of 800 feet. This device does not require a direct line of site to activate receiver modules. The power supply is a 12-vdc-battery source, which draws 3.3 milliamps during operation. This item is an off the self device manufactured by VISITECT Incorporated.

Once the signal is sent, the receiver will activate the voice module and amplifier. The receiver is designed to work along with the transmitter at a transmission frequency of 318 mhz. The range is up to 800 feet and operates of an 11-24 volts deregulated voltage or 5-12 volts regulated. The output voltage is 9 volts dc (30 ma. Max) or 5-14 volts if regulator is bypassed. Current draw is 12-15 miiliamps. Output signal is 1 momentary and 2 latching H/L gated signals. The device can operate up to 3 channels with additional circuitry.

Once the receiver is activated, the stereo amplifier overrides the main stereo circuitry and activates the voice record play back module. The bandwidth is 20 Hz to 15 KHz with a voltage gain of 26 dB. The device generates 22 watts per channel into 4 ohms to drive 4 to 8 ohm speakers. The amplifier operates of off a 12 to 18 vdc power source typically used by standard industry designed stereo systems.

### BRIEF DESCRIPTION OF THE DRAWINGS

The invention and the variations of like parts and the concomitant advantages will be better understood and appreciated by persons skilled in the field of electronic device assembly to which the invention pertains in Figure of the following description given in conjunction with the accompanying which illustrates preferred embodiments. In the drawings:

PG 2 is a list of all parts associated with the apparatus of the present invention.

Figure A is a diagram indicating the location, orientation and position of T1 transmitter, RC receivers, P1 potentiometer and ¼ inch standoffs.

Figure B is a diagram indicating the location, orientation and position of C1 two pin quick disconnect cable/connector, C2 four pin connector and F1 fuse holder.

Figure C is a diagram indicating the orientation and position of R1 DPDT relay, R2 DPDT relay, R1A socket, R2A socket into R3 bracket.

Figure D is a diagram indicating the location, orientation and position of Figure C assembly is located in EWDEVICE1001 chassis.

Figure E is a diagram indicating the location, orientation and position of AMP audio amplifier.

Figure F is a diagram indicating the location, orientation and position of P1 Potentiometer.

Figure G is a schematic block diagram indicating the interconnection of MC voice record/play back module, H1 tip switch, H1A voltage regulator, H1B resistor, H1C diode, H1D output transformer, H1E heat sinks onto H1F micro board. Location of parts is optional.

Figure H is a schematic block diagram indicating the interconnection of all components.

### DETAILED DESCRIPTION OF THE INVENTION

Combined Figures A & G

Figure A is a diagram indicating the location, orientation and position of T1 transmitter, RC receivers, P1 potentiometer and ¼ inch standoffs.

The input signal activates RC receiver which transfers the input signal to the T1 transmitter which activates the H1 tip switch (H1A through H1F Figure G) and T1 transmitter to Figure B interconnection wire assembly.

Figure B is a diagram indicating the location, orientation and position of C1 two pin quick disconnect cable/connector, C2 four pin connector and F1 fuse holder.

This diagram provides the power into the internal components and provides the interconnection pathway for signal output to the external audio and speakers.

Figure C is a diagram indicating the orientation and position of R1 DPDT relay, R2 DPDT relay, R1A socket, R2A socket into R3 bracket.

The RC receiver (Figure A) provides the input signal activating R1 DPDT relay which forwards input data to R2 DPDT relay activating MC (Figure G) voice record/play back module. MC voice record/play back module forwards input data to the internal AMP amplifier Figure E.

Figure D is a diagram indicating the location, orientation and position of Figure C assembly is located in EWDEVICE1001 chassis.

This depicts the location and interconnections (Figure H) for relaying the input signal beginning the chain of event's which provides the over ride of the external audio system.

Figure E is a diagram indicating the location, orientation and position of AMP audio amplifier.

The AMP amplifier receives the input signal from MC (Figure G) voice record/play back module and sends output signal through interconnect wiring (Figure B & Schematic Figure H) to external audio amplifier and speakers. Figure F is a diagram indicating the location, orientation and position of P1 Potentiometer.

This depicts the installation of P1 10K ohm potentiometer, which controls the level of audio transmission to the external audio source. This is typically set at the assembly level and my be adjusted at installation.

Note: Additional installation mounting holes and hardware are determined at the assembly level. Due to the evolving COT (off the self-items) it may be necessary to change mounting schemes in addition to hardware required.

I claim:

1. A process for an on board communication warring device for alerting and communicating alerts in a mobile vehicle having an radio engaged in or not engaged in radio transmission while driving a vehicle having an internal device backbone to which electronic switch's of the device are electronically engaged, the electronic switch's are activated by relays monitoring certain radio components in contact with the on board communication warning device through communication means engaged by external communication transmitter, comprising the steps of:
receiving an indication of an external transmission from an electronic mobile transmitter through the vehicle internal communication warning device and the communication means;
comparing the indication of an vehicle radio component's expected parameters in a reception of radio signals, performing the further steps of:
determining if a radio is engaged in receiving radio reception signal;
determining if a radio is not engaged in receiving radio reception signal;

2. The process of claim 1, wherein:
transmitting a notice to the vehicle for a driver of the vehicle of the most probable cause of the difference from the manufacturer's expected parameters of a radio enegaged before the step of providing the vehicle driver with a audible alert warring of an emergency vehicle traveling in the general direction of their vehicle in service of an emergency.

3. The process of claim 1, wherein:
transmitting a notice to the vehicle for a driver of the vehicle of the most probable cause of the difference from the manufacturer's expected parameters of a radio not enegaged before the step of providing the vehicle driver with a audible alert warring of an emergency vehicle traveling in the general direction of their vehicle in service of an emergency.
